(19) United States
(12) Patent Application Publication
(10) Pub. No.: US 2014/0195899 A1
(43) Pub. Date: Jul. 10, 2014

(54) COLLABORATIVE PRESENTATION OF EXTRACTED INFORMATION

(71) Applicant: INTERNATIONAL BUSINESS MACHINES CORPORATION, Armonk, NY (US)

(72) Inventors: Paul R. Bastide, Boxford, MA (US); Matthew E. Broomhall, Goffstown, NH (US); Stanley K. Jerrard-Dunne, Dublin (IE); Robert E. Loredo, North Miami Beach, FL (US); Michael L. Taylor, Boca Raton, FL (US)

(73) Assignee: International Business Machines Corporation, Armonk, NY (US)

(21) Appl. No.: 13/733,965

(22) Filed: Jan. 4, 2013

(51) Int. Cl. G06F 17/24

(52) U.S. Cl. CPC G06F 17/24
USPC 715/256

(57) ABSTRACT

An approach for presenting revision history for collaboratively edited documents. In one aspect, the approach comprises a computing system tracking edits to documents according to an ordering of edits without changing the document, responsive to a requestor and a responder utilizing one or more collaborative tools during editing sessions of the documents. The approach further comprises the computing system identifying designated portions of edits of information of the documents. Moreover, the approach comprises the computing system extracting the designated portions of edits of information of the documents, and responsive to the requestor or the responder enabling a time view on the one or more collaborative tools, presenting extracted designated portions of the edits of the document.

### FIELD OF THE INVENTION

The present invention relates generally to collaborative document editing, and more particularly to collaborative editing of documents, and presentation of extracted information of the documents between a plurality of actors.

### BACKGROUND OF THE INVENTION

The Internet is a global network of computers and networks joined together by gateways that handle data transfer and conversion of messages from a protocol of a sending network to a protocol of a receiving network. Information transmitted between computers travels over the Internet through a variety of languages also referred to as protocols. The Internet can also be especially conductive to conducting electronic commerce and other business, or personal transactions conducted between one or more users.

Furthermore, collaborative transmission of electronic information between users can provide increased productivity and effectiveness, in either business or personal transactions. For example, through the use of a user interface, such as a web browser, a user can have access to a plurality of electronic documents, containing sensitive or confidential information that can be transmitted between one or more users over one or more collaborative editing tools over the internet. In particular, collaborative editors are collaborative software applications that allow a plurality of users or actors to edit electronic documents or information by using a plurality of computer.

### SUMMARY

In one embodiment, a method is provided for presenting revision history for collaboratively edited documents within a computer system. The method comprises, responsive to a requestor and a responder utilizing one or more collaborative tools during editing sessions of documents, the computer system tracking edits to the documents according to an ordering of edits without changing the document. The method further comprises the computer system identifying designated portions of edits of information of the documents. The method further comprises the computer system extracting the designated portions of edits of information of the document. The method further comprises responsive to the requestor or the responder enabling a time view on the one or more collaborative tools, the computing system presenting extracted designated portions of the edits of the document.

In another embodiment, a computer system is provided for presenting revision history for collaboratively edited documents. The computer system comprises one or more processors, one or more computer-readable memories, one or more computer-readable tangible storage devices and program instructions which are stored on at least one of the one or more storage devices for execution by at least one of the one or more processors via at least one of the one or more memories. The computer system further comprises program instructions to track edits to documents according to an ordering of edits without changing the document, responsive to a requestor or a responder utilizing one or more collaborative tools during editing sessions of the documents. The computer system further comprises program instructions to identify designated portions of edits of information of the documents. The computer system further comprises program instructions to extract the designated portions of edits of information of the document. The computer system further comprises program instructions to present extracted designated portions of the edits of the document, responsive to the requestor or the responder enabling a time view on the one or more collaborative tools.

In another embodiment, a computer program product is provided for presenting revision history for collaboratively edited documents. The computer program product comprises one or more processors, one or more computer-readable memories, one or more computer-readable tangible storage devices and program instructions which are stored on at least one of the one or more storage devices for execution by at least one of the one or more processors via at least one of the one or more memories. The computer program product further comprises program instructions to track edits to documents according to an ordering of edits without changing the document, responsive to a requestor or a responder utilizing one or more collaborative tools during editing sessions of the documents. The computer system further comprises program instructions to identify designated portions of edits of information of the documents. The computer system further comprises program instructions to extract the designated portions of edits of information of the document. The computer system further comprises program instructions to present extracted designated portions of the edits of the document, responsive to the requestor or the responder enabling a time view on the one or more collaborative tools.

### BRIEF DESCRIPTION OF THE SEVERAL VIEWS OF THE DRAWINGS

Novel characteristics of the invention are set forth in the appended claims. The invention itself, however, as well as preferred mode of use, further objectives, and advantages thereof, will be best understood by reference to the following detailed description of the invention when read in conjunction with the accompanying Figures, wherein, like reference numerals indicate like components, and:

FIG. 1 is a functional block diagram of a collaborative presentation system, in accordance with embodiments of the present invention.

FIG. 2 is a functional block diagram illustrating components of a client device, in accordance with an embodiment of the present invention.

FIG. 3 illustrates an exemplary view of user interface elements of a client device, in accordance with an embodiment of the present invention.

FIG. 4 illustrates an alternative exemplary view of user interface elements of a client device, in accordance with an embodiment of the present invention.

FIG. 5 is a functional block diagram illustrating components of server device, in accordance with embodiments of the present invention.

FIG. 6 is a flowchart depicting steps performed by a server program of a server device of FIG. 1, in accordance with embodiments of the present invention.

FIG. 7 illustrates a block diagram of components of a computer system, in accordance with embodiments of the present invention.

### DETAILED DESCRIPTION

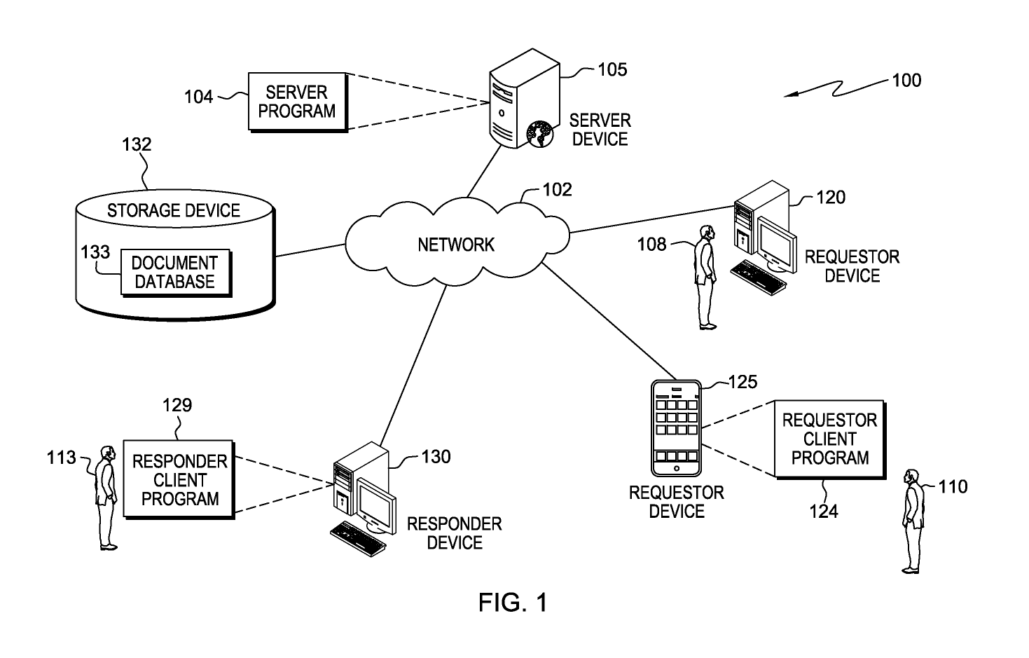

The present invention will now be described in conjunction with the Figures. Referring to FIG. 1, collaborative presentation system 100 for presenting edits of documents, and progression of the edits of the documents, over time without modifying the current state of the document during collaborative editing sessions. Collaborative presentation system 100 comprises network 102, requestor devices 120, 125, responder device 130, server device 105 and storage device 132.

Requestor devices 120, 125, responder device 130 and storage device 132 are clients to server device 105, interconnected over network 102. Requestor devices 120, 125, responder device 130 and storage device 132 operate over network 102 with server device 105 to facilitate presentation of editing of documents or updates of progression of the edited documents over a period of time. The edited documents are presented in scope of designated sections or range of time during the collaborative sessions. Requestors 108, 110 can be a host that initiates a request to share presentations of collaboratively edited documents with participants including, for example, responder 113. Furthermore, roles of collaboratively presenting edited documents in collaborative presentation system 100 between requestors 108, 110 and responder 113, are interchangeable, as described in more details below, in accordance with embodiments of the present invention.

Requestor devices 120, 125 can be, for example, a laptop, tablet, or notebook personal computer (PC), a desktop computer, a mainframe or mini computer, a personal digital assistant (PDA), or a smart phone such as a Blackberry® (Blackberry is a registered trademark of Research in Motion Limited (RIM) Inc., in the United States, other countries, or both) or iPhone® (iPhone is a registered trademark of Apple Inc., in the United States, other countries, or both), respectively. Requestor devices 120, 125 comprises requestor client program 124. Requestor client program 124 can be any type of software application that is compatible to edit portions of information in documents, and present progression of the edited documents during collaborative sessions.

Responder device 130 can be, for example, a laptop, tablet, or notebook personal computer (PC), a desktop computer, a mainframe or mini computer, a personal digital assistant (PDA), or a smart phone such as a Blackberry® (Blackberry is a registered trademark of Research in Motion Limited (RIM) Inc., in the United States, other countries, or both) or iPhone® (iPhone is a registered trademark of Apple Inc., in the United States, other countries, or both), respectively. Responder device 130 comprises responder client program 129. Responder client program 129 performs functions to edit documents, and present progression of the edited or unedited sections of the documents, during collaborative editing sessions, in accordance with embodiments of the present invention.

Server device 105 can be, for example, a server computer system such as a management server, a web server, or any other electronic device or computing system capable of receiving and sending data during collaborative editing sessions of collaborative presentation system 100. Server device 105 can also represent a “cloud” of computers interconnected by one or more networks, wherein server device 105 can be a primary server for a computing system utilizing clustered computers when accessed through network 102. For example, a cloud computing system can be an implementation of a collaborative form editing system for dynamically presenting revisions of the edited documents during collaborative editing sessions between requestors 108, 110 and responders 113. Server device 105 includes server program 104. Server program 104 performs all necessary functions to edit portions of information of documents, and present the edited portions of document for display on requestor devices 120, 125 or responder device 130.

Storage device 132 can be any type of storage device, storage server, storage area network, redundant array of independent discs (RAID), cloud storage service, or any type of data storage. Storage device 132 includes document database 133. Document database 133 is a database of edits or unedited documents stored in document database 133 for later retrieval and presentation of the retrieved documents during collaborative editing sessions over network 102, in accordance with embodiments of the present invention.

Network 102 includes one or more networks of any kind that can provide communication links between various devices and computers connected together within collaborative presentation system 100. Network 102 can also include connections, such as wired communication links, wireless communication links, or fiber optic cables. In addition, network 102 can be implemented as a number of different types of networks, including, for example, a local area network (LAN), wide area network (WAN) or a packet switched telephone network (PSTN), or some other networked system.

Collaborative presentation system 100 can utilize the Internet with network 102 representing a worldwide collection of networks. The term “Internet” as used according to embodiments of the present invention refers to a network or networks that uses certain protocols, such as the TCP/IP protocol, and possibly other protocols such as the hypertext transfer protocol (HTTP) for hypertext markup language (HTML) documents that make up the world wide Web (the web). Further, content from the Internet is often provided by content servers, including, for example, server program 104 can be transmitted to client display devices, including, for example requestor devices 120, 125 and responder device 130. Furthermore, at the heart of the Internet is a backbone of high-speed data communication lines between major nodes or host computers, consisting of thousands of commercial, government, educational and other documents that can be transferred in a collaborative application between requestors 108, 110 and responder 113, in accordance with embodiments of the present invention.

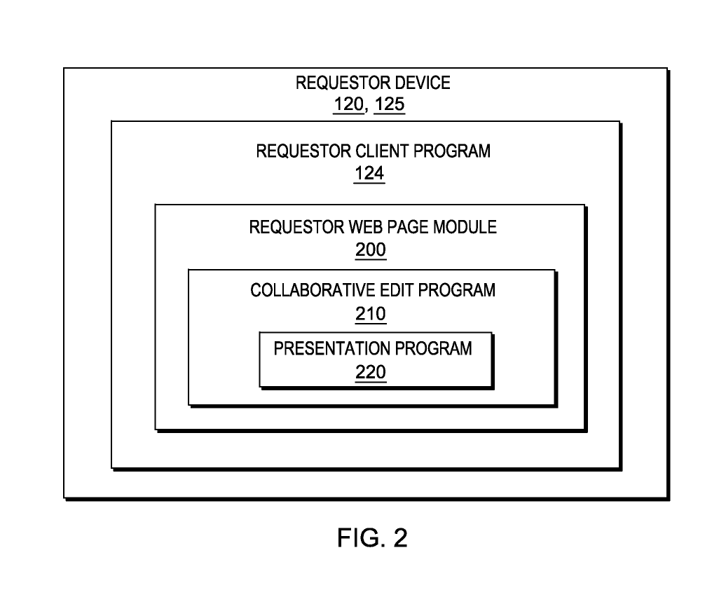

FIG. 2 is a functional block diagram illustrating program components of requestor devices 120, 125, in accordance with an embodiment of the present invention.

Requestor devices 120, 125 comprises requestor client program 124. Requestor client program 124 can, among other things, retrieve and display content accessible via network 102, such as web pages. In one aspect, requestor client program 124 is a web browser. Examples of web browsers include Internet Explorer® (Internet Explorer is a trademark of Microsoft Inc., in the United States, other countries or both), Firefox® (Firefox is a trademark of Mozilla Corporation, in the United States other countries, or both), Safari® (Safari is a trademark of Apple, Inc. in the United States, other countries, or both) and Google Chrome™ (Google Chrome is a trademark of Google, Inc. in the United States, other countries, or both), respectively.

Requestor client program 124 comprises requestor web page module 200. Requestor web page module 200 is a web browser plugin/add-on that extends the functionality of requestor client program 124 by adding additional user interface elements to a user interface of requestor client program 124. The additional user interface elements allow requestors 108, 110 to edit portions of information of documents, and present the edited portions of information. In one embodiment, requestor web page module 200 comprises a web page received in requestor client program 124 from server program 104. The web page received in requestor client program 124 can include program code, such as HyperText Markup Language (HTML) code or JavaScript code that, when executed, adds one or more user interface elements to requestor client program 124.

Requestor web page module 200 comprises collaborative edit program 210. Collaborative edit program 210 is a web browser plugin/add on that extends the functionality of requestor web page module 200 by adding additional user interface elements to a user interface of requestor web page module 200. Furthermore, collaborative edit program 210 is a collaborative editing tool for editing documents.

In one embodiment of the present invention, documents can be edited in collaborative edit program 210 and progression of edited or unedited sections of the document is presented by presentation program 220 of collaborative edit program 210. In one aspect, presentation of edited or unedited sections of documents on collaborative edit program 210 can be displayed in scope of a section or a set range of time on presentation program 220. In particular, collaborative edit program 210 provides a user interface that enables editing of documents, and wherein the edited documents are tracked and stored for retrieval in document database 133. In one embodiment, server program 104 is adapted to further transmit the stored edited documents to collaborative edit program 210 for presentation, or additional editing of the edited documents, in accordance with embodiments of the present invention.

Collaborative edit program 210 monitors all user activities of collaboratively edited documents during collaborative sessions, including, but not limited to monitoring and storing one or more sections of edited documents, monitoring and storing one or more updates to the edited documents, monitoring and storing timestamp of the change of the edited documents, and monitoring and storing current editing state of documents, for future retrieval, and presentation. The timestamp feature of collaborative edit program 210 can be utilized as a primary function for sorting and presenting edited documents. Collaborative edit program 210 includes presentation program 220. Presentation program 220 presents decorating features of edits of the edited documents during the collaborative editing sessions. For example, presentation program 220 presents overlays and outlines of sections of the edited documents during collaborative editing sessions, and also presents additional decorating features to decorated edits of the edited documents.

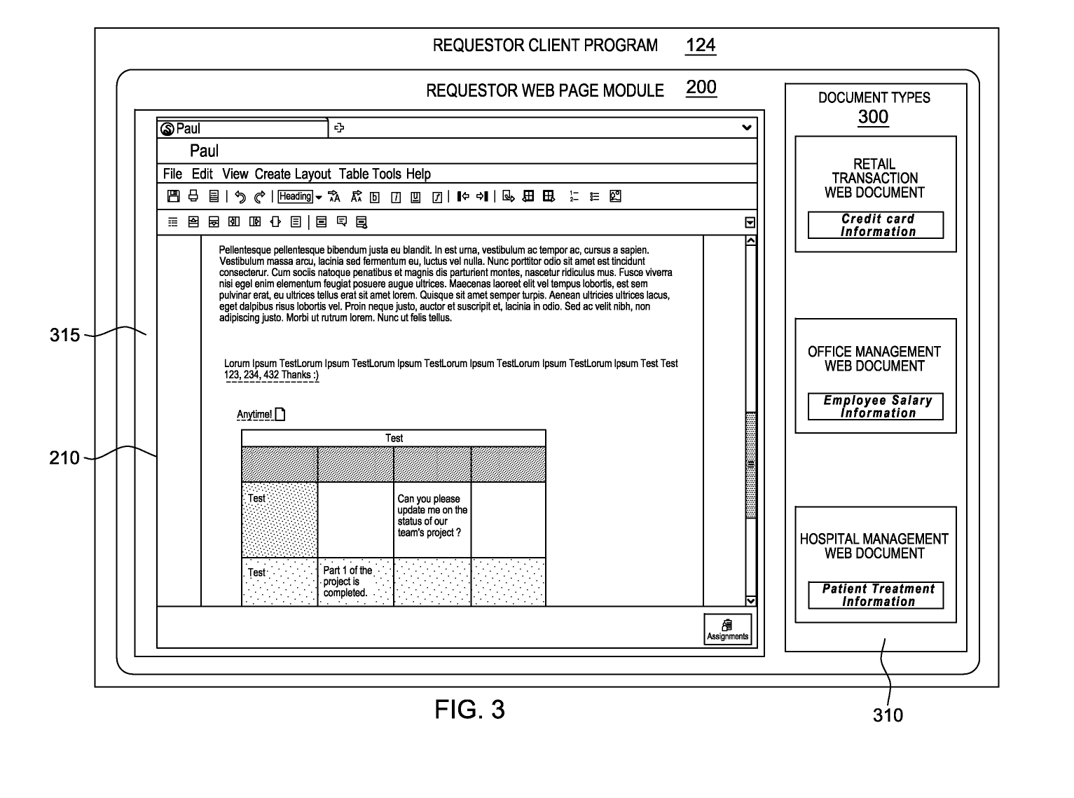

FIG. 3 is an exemplary view of user interface elements added to a user interface of requestor web page module 200 by collaborative edit program 210, in accordance with embodiments of the present invention.

Collaborative edit program 210 populates the user interface of requestor web page module 200 with document types 300. Document types 300 can be collaboratively edited by either of requestor 108, 110 or responder 113 on canvas 315. Document types 300 can comprise a collection of linked individual pages, each with optional scrolling and non-scrolling areas, text, images, and other media embedded or electronic web document pages. For example, documents types 300 can comprise confidential or non confidential information relating to online retail transactions, office documents, or any other electronic or non electronic information that can be collaboratively edited by collaborative edit program 210. In other embodiments, document types 300 can be any application processing system, for editing or organizing information between requestor 108, 110 or responder 113, in accordance with embodiments of the present invention.

Embodiments of the present invention are further adapted to allow either of requestor 108, 110 or responder 113 to see editing progression of one or more document types 300, retrieved from document database 133, over time without modifying the current state of document types 300 during collaborative sessions. In one embodiment, document types 300 can be displayed in selection area 310. Furthermore, collaborative edit program 210 allows requestors 108, 110 to arrange document types 300 on canvas 315 for editing or presentation of the edited document types 300 in a layout according to a preference of document types 300 that requestor 108, 110 desires to collaboratively share with responder 113. In addition, editing sessions of the document types 300 on canvas 315 are stored in document database 133. Edited document types 300 can also be archived in folders of collaborative edit program 210 for retrieval. In one aspect, collaborative edit program 210 can contain preexisting document types 300 on canvas 315, for editing or dynamic presentation of the edited document types 300. Furthermore, requestors 108, 110 can drag and drop one or more document types 300 from selection area 310 onto canvas 315. In another embodiment, requestors 108, 110 can copy one or more document types 300 from selection area 310, and paste the copied one or more document types 300 onto canvas 315. In yet another embodiment, requestor 108, 110 can resize one or more document types 300 dropped or copied onto canvas 315.

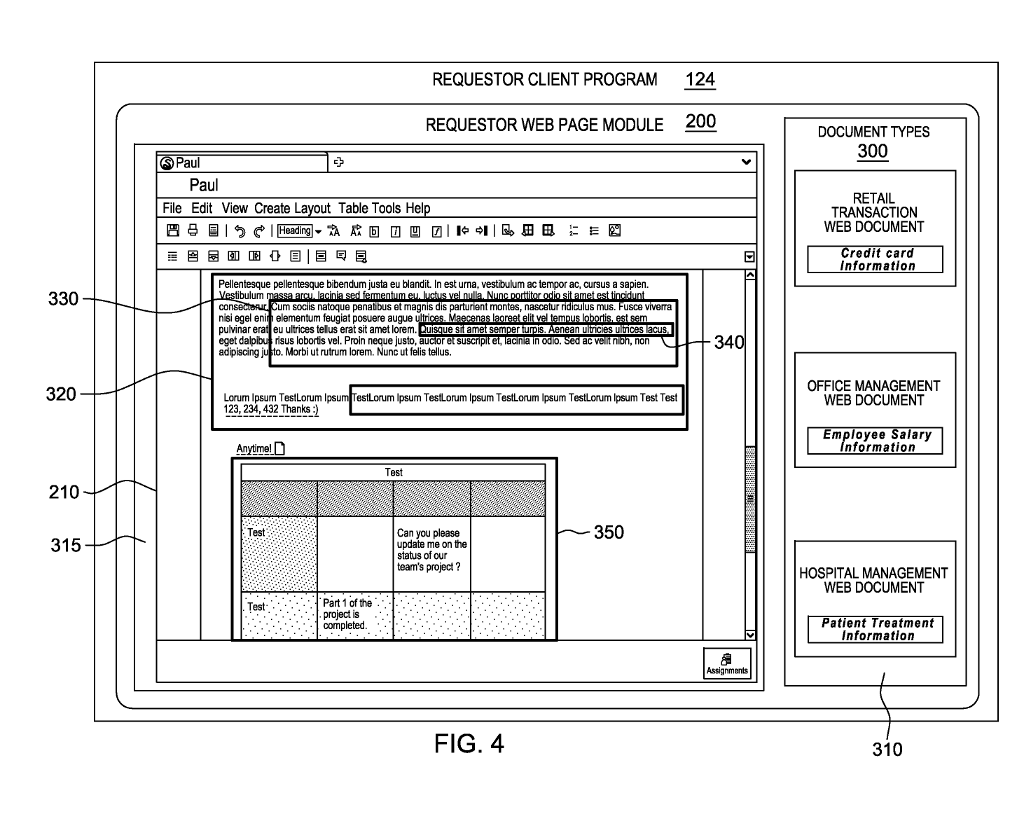

FIG. 4 illustrates an alternative embodiment of user interface elements added to a user interface of requestor web page module 200 by collaborative edit program 210, in accordance with embodiments of the present invention.

In the depicted embodiment, either of requestor 108, 110 or responder 113, can enable or disable presentation program 220 during collaborative editing sessions of document types 300. In one aspect, if either of requestors 108, 110 or responder 113 disables presentation program 220, a notification will displayed by presentation program 220 to all members of the collaborative sessions, indicating that edits to document types 300 on canvas 315 are not displayed by either of requestor 108, 110 or responder 113. On the other hand, once presentation program 220 is enabled, server program 104 transmits extractions of edited documents types 300, including editing history of document types 300 for display by presentation program 220 during collaborative editing sessions. Furthermore, once enabled, presentation program 220 can also be configured to present unique features of the extracted information of document types 300 by server program 104, including, for example, decorations of changes or edits to document types 300, in accordance with embodiments of the present invention

In one aspect of the present invention, presentation program 220 presents decorations to section of edits or changes to document types 300 on canvas 315. For example, the decorated edits are presented as edit A 320, edit B 330, edit C 340, and edit D 350. In particular, presentation program 220 can present the decorations of the edits based on color nodes in HTML. For instance, if server program 104 detects various sections of edits to documents types 300 within a larger section of document types 300, server program 104 extracts highlights of the edits, and presentation program 220 presents the highlights in the form of an entire edited section of document types 300, instead of presenting each specific edits within the large section. For example, in the depicted embodiment, a change or edit to three sentences of edit B 330 in a five sentence paragraph of edit A 320, will highlight edits to edit A 320, rather than a presentation of each sentence that is changed, updated or edited. As depicted, edit A 320 is primarily highlighted as being changed or edit, while edit B 330 is presented as being edited within edit A 320.

In another aspect of the present invention, presentation program 220 also presents a unique identifier for each edit of document types 300. The identifier is unique for either the entire collaborative session of collaborative edit program 210 or specific to each requestor 108, 110 or responder 113 of the collaborative editing session. Furthermore, sections of document types 300 that are not edited can also include unique identifiers. The unique identifiers of unedited or unchanged sections to document types 300 can be associated with the originator or creator of document types 300, for example, either of requestor 108, 110 or responder 113, whom originated the unedited document types 300.

Assignment of unique identifiers to unedited document types 300 enables presentation program 220 to display specific sections of document types 300 that have not been edited after the original document types 300 was created. Edits to document types 300 that are created and stored in document database 133 after the original creation of unedited document types 300 can be presented separately from edited document types 300 on canvas 315. Presentation program 220 also presents or displays unique colors assigned to edited document types 300. The unique colors can be assigned by an extraction module of server program 104, based on the timestamp of edited document types 300. The unique colors can also include indicators that identify variations of timestamp displayed by presentation program 220, for example, presentation program 220 can display unique colors based on the timestamp, including for instance, older edits of documents types 300 are displayed by presentation program 220 with light colors, and more recent edits are displayed with darker colors. In one embodiment, display of unique colors by presentation program 220 allows either of requestor 108, 110 or responder 113 to see timestamp displays of edited or unedited document types 300, in accordance with embodiments of the present invention.

In yet another aspect, presentation program 220 presents overlays of edits to document types 300, and identifies and presents the overlays of the edits based on a mixture of colors, intensity of border of the outermost edits, and overrides the display of the inner most edits, animation of any edits either chronologically or by resolution to the section to word to character of the edited document types 300. The presentation of resolution to the section to word character can be presented based on playback mode. Furthermore, in areas where there are many overlays, presentation program 220 presents borders to the edited document types 300, wherein the borders provide a light but visible separation of editing history to document types 300, for instance, dotted line vs. solid lines of the edits.

In yet another aspect, presentation program 220 further presents overlaps of the decorated edits by server program 104, based on any additional edits or features added to document types 300 during collaborative sessions. Furthermore, presentation program 220 generates the decorated edits in chronological order for viewing by requestor 108, 110 or responder 113 engaged in one or more editing collaborative sessions of at least one document types 300. For example, presentation program 220 arranges the updates or edits to document types 300 in chronological on canvas based on timestamp of change, and displays the edited documents types 300 to all members of the collaborative session. Presentation program 220 can further enable either requestor 108, 100 or responder 113 to reset start time of the presentation of edited documents types 300, for example, enabling presentation only of changes of the current day of viewing the presentation, rather than from the initial change, in accordance with embodiments of the present invention.

In yet another embodiment, presentation program 220 further presents edits to document types 300 as visual elements. The visual elements summarize the section of document types 300 which was edited by enabling either of requestor 108, 110 or responder 113 to utilized scrolling mechanisms of presentation program 220 to see resolution of edits at the paragraph, page section levels of the edited document types 300. Particularly, the scrolling mechanism allows requestor 108, 110 or responder 113 to see the resolution of changes to the edited document types 300, including for example, edits to sentences, tables, or images of the edited document types 300 on canvas. For example, as a user decreases scrolling speed on edited document types 300, the user sees the resolution of change at a granular level, for example, the sentence, table, or image level of the edited document types 300. In another example, in the event the user stops scrolling, the user then sees the resolution of the change of edited document types 300 at an even lower granularity level, for example, character change or word change. Further, presentation program 220 is adapted to present an animated sequence of the edits which can demonstrate the changes to document types 300, similar to a video stream of changes. The animated sequence of presentation program 220 can be interactive and enable revision history of the edited document types on canvas 315, in accordance with embodiments of the present invention.

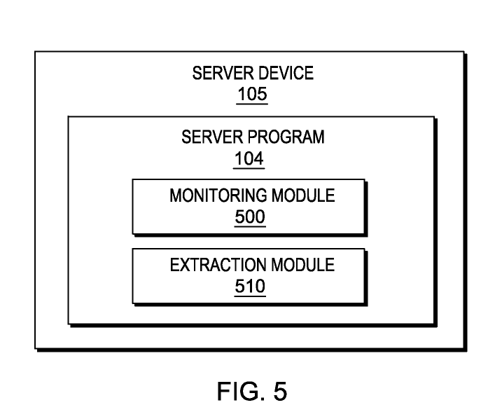

FIG. 5 is a functional block diagram illustrating program components of server device 105 in accordance with embodiments of the present invention.

Server program 104 performs functions to monitor collaborative edits to documents types 300, and store all user activities regarding the collaboratively edited document types 300, including, but not limited to monitoring and storing sections of the edited document types 300, monitoring and storing one or more updates to the edits or changes to the document types 300, timestamp of the change to the edits, and current editing state of document type 300 on canvas 315. In one embodiment, server program 104 is further configured to transmit monitored edits of document types 300, and progression of the edited document types 300 to collaborative edit program 210, for presentation by presentation program 220. Server program 104 includes monitoring module 500 and extraction module 510. Monitoring module 500 monitors user interactions of collaborative editing sessions of document types 300 periodically, randomly, and/or using event-based monitoring of the edited document types 300 between requestor 108, 110 and responder 113. The user interactions include one or more of editing of document types 300 on canvas, tracking or storing of the edited document types 300 in database, and presenting the editing document types 300 on canvas 315 during collaborative editing sessions. In one aspect, monitoring module 500 receives a request from requestor client program 124 to present edited document types 300 for viewing of progression of the edits on presentation program 220. The request can further include, additional editing of the document types 300 on canvas 315 of collaborative edit program 210, in accordance with embodiments of the present invention.

Extraction module 510 is configured to extract portions of edited information on document types 300. Extraction module 510 extracts certain portions of information on document types 300 while not extracting other portions on preference by either requestor 108, 110 or responder 113, to extract selected edited portion of document types 300. Furthermore, once the information is extracted, server program 104 is further adapted to replace edited portions of document types 300 that are extracted by extraction module 510, with an updated version of the extracted document types 300.

Moreover, once presentation program 220 is enabled by either of requestor 108, 110 or responder 113, server program 104 populates user interface of presentation program 220 with the extracted portions of edited information of document types 300, transmitted to collaborative edit program 210 for display by presentation program 220. In particular, extraction module 510 receives information containing multiple edited elements of document types 300 during collaborative sessions on collaborative edit program 210. Extraction module 510 further receives a request to transmit extracted edits of document types 300 for display by presentation program 220. In one aspect, extraction module 510 stores extracted edits of document types 300 in document database 133 for future retrieval and display by presentation program 220.

In one embodiment, extraction module 510 decorates sections of edited document types 300 with unique colors or identifiers for display by presentation program 220. In addition, a matching algorithm can be utilized by extraction module 510 to extract specific portions document types 300 designated or marked as edits in collaborative edit program 210. For example, extraction module 510 can extract selected portions of document types 300, such as, for example, information appearing in edit A 330 or edit B 340 on canvas 315, with unique colors based on timestamp of the edits in collaborative edit program 210.

Specifically, extraction module 510 replaces information identified by server program 104 as edited information of document types 300 by a fixed length string, and ensures that edited information pertaining to the fixed-length is transmitted by server program 104 to collaborative edit program 210 for display by presentation program 220. In another embodiment, any extraction program or mechanism can be utilized by extraction module 510 to extract portions of edited information in document types 300, in accordance with embodiments of the present invention.

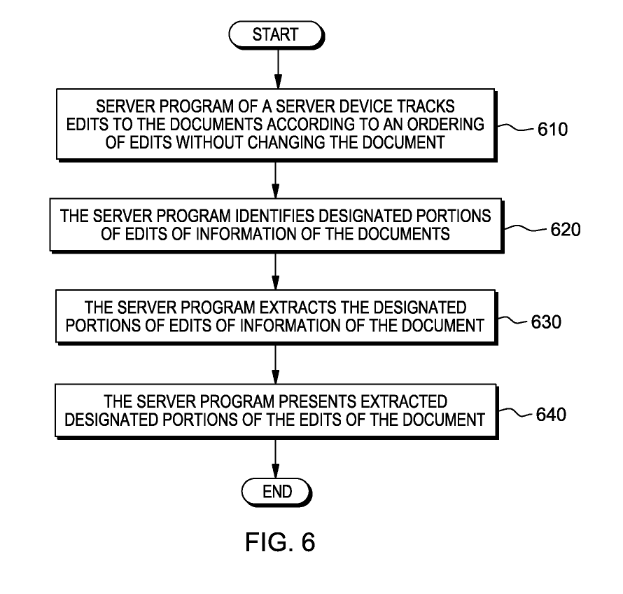

FIG. 6 is a flowchart depicting steps performed by server program 105 of FIG. 1, in accordance with embodiments of the present invention.

In step 610, server program 104 tracks edit to one or more document types 300 according to an ordering of the edits without changing current state of document types 300 in canvas 315 of collaborative edit program 210. In step 620, server program 104 identifies designated portions of edits of information of document types 300 on canvas 315. In step 630, server program 104 extracts the designated portions of the edits of document types 300, in accordance with embodiments of the present invention. In step 640, server program 104 presents the extracted designated portions of the edits of document types. In one aspect, server program 104 displays the extracted designated portion on collaborative edit program 210. Presentation program 220 can also be enabled or disabled by either of responders 108, 110 and requestor 113 during collaborative editing sessions on collaborative edit program 210 to display the extracted. The extracted designated portions of edits are transmitted to a user interface of presentation program 220 to either requestor 108, 110 or responder 113.

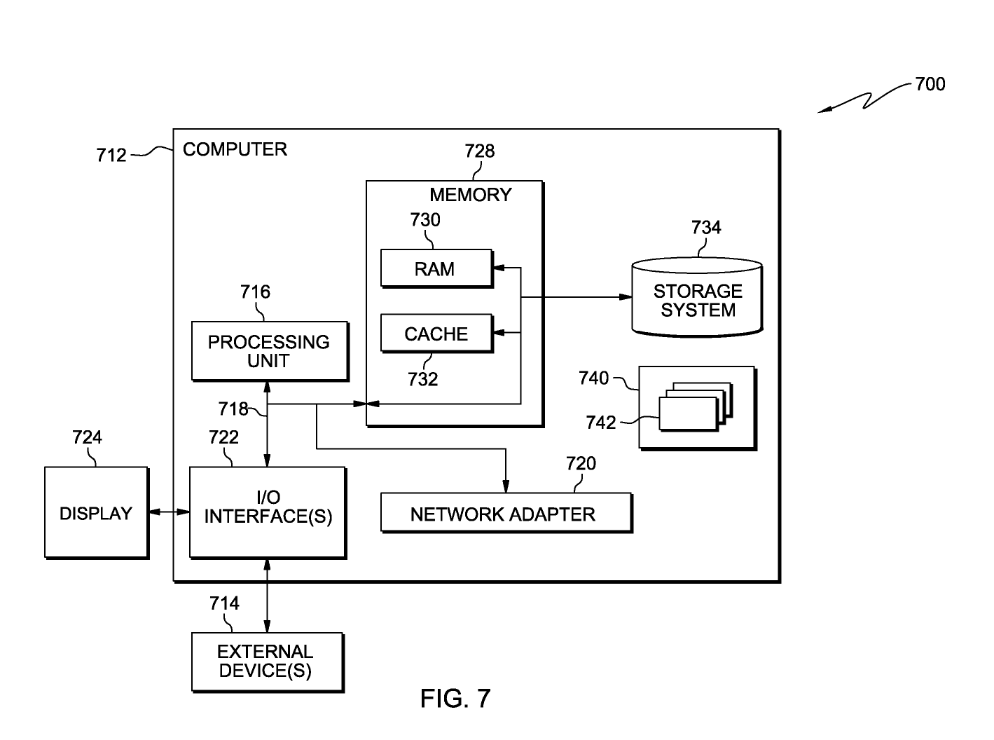

FIG. 7 is a functional block diagram of a computer system, in accordance with an embodiment of the present invention.

Computer system 700 is only one example of a suitable computer system and is not intended to suggest any limitation as to the scope of use or functionality of embodiments of the invention described herein. Regardless, computer system 700 is capable of being implemented and/or performing any of the functionality set forth hereinabove. In computer system 700 there is computer 712, which is operational with numerous other general purpose or special purpose computing system environments or configurations. Examples of well-known computing systems, environments, and/or configurations that can be suitable for use with computer 712 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like. Each one of requestor devices 120, 125, responder device 130 and server device 105 can include or can be implemented as an instance of computer 712.

Computer 712 can be described in the general context of computer system executable instructions, such as program modules, being executed by a computer system. Generally, program modules can include routines, programs, objects, components, logic, data structures, and so on that perform particular tasks or implement particular abstract data types. Computer 712 can be practiced in distributed cloud computing environments where tasks are performed by remote processing devices that are linked through a communications network. In a distributed cloud computing environment, program modules can be located in both local and remote computer system storage media including memory storage devices.

As further shown in FIG. 7, computer 712 is shown in the form of a general-purpose computing device. The components of computer 712 can include, but are not limited to, one or more processors or processing units 716, memory 728, and bus 718 that couples various system components including memory 728 to processing unit 716.

Bus 718 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer 712 typically includes a variety of computer system readable media. Such media can be any available media that is accessible by computer 712, and includes both volatile and non-volatile media, and removable and non-removable media. Memory 728 includes computer system readable media in the form of volatile memory, such as random access memory (RAM) 730 and/or cache 732.

Computer 712 can further include other removable/non-removable, volatile/non-volatile computer system storage media. By way of example only, storage system 734 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 718 by one or more data media interfaces. As will be further depicted and described below, memory 728 can include at least one program product having a set (e.g., at least one) of program modules that are configured to carry out the functions of embodiments of the invention.

Requestor client program 124, responder client program 129 and server program 104 can be stored in memory 728 by way of example, and not limitation, as well as, an operating system, one or more application programs, other program modules, and program data. Each of the operating system, one or more application programs, other program modules, and program data or some combination thereof, can include an implementation of a networking environment. Program modules 742 generally carry out the functions and/or methodologies of embodiments of the invention as described herein. Each one of requestor client program 124, responder client program 129 and server program 104 are implemented as or are an instance of program 740.

Computer 712 can also communicate with one or more external devices 714 such as a keyboard, a pointing device, etc., as well as display 724; one or more devices that enable a user to interact with computer 712; and/or any devices (e.g., network card, modem, etc.) that enable computer 712 to communicate with one or more other computing devices. Such communication occurs via Input/Output (I/O) interfaces 722. Still yet, computer 712 communicates with one or more networks such as a local area network (LAN), a general wide area network (WAN), and/or a public network (e.g., the Internet) via network adapter 720. As depicted, network adapter 720 communicates with the other components of computer 712 via bus 718. It should be understood that although not shown, other hardware and/or software components can be used in conjunction with computer 712. Examples include, but are not limited to: microcode, device drivers, redundant processing units, external disk drive arrays, RAID systems, tape drives, and data archival storage systems, etc.

The flowchart and block diagrams in the Figures illustrate the architecture, functionality, and operation of possible implementations of systems, methods and computer program products according to various embodiments of the present invention. In this regard, each block in the flowchart or block diagrams can represent a module, segment, or portion of code, which comprises one or more executable instructions for implementing the specified logical function(s). It should also be noted that, in some alternative implementations, the functions noted in the block can occur out of the order noted in the Figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustrations are implemented by special purpose hardware-based systems that perform the specified functions or acts, or combinations of special purpose hardware and computer instructions.

As will be appreciated by one skilled in the art, embodiments of the present invention can be embodied as a system, method or computer program product. Accordingly, embodiments of the present invention can take the form of an entirely hardware embodiment, an entirely software embodiment (including firmware, resident software, micro-code, etc.) or an embodiment combining software and hardware aspects that can all generally be referred to herein as a “circuit,” “module” or “system.” Furthermore, embodiments of the present invention can take the form of a computer program product embodied in one or more computer-readable medium(s) having computer-readable program code embodied thereon.

In addition, any combination of one or more computer-readable medium(s) can be utilized. The computer-readable medium can be a computer-readable signal medium or a computer-readable storage medium. A computer-readable storage medium can be for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium can include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium can be any tangible medium that contains, or stores a program for use by or in connection with an instruction execution system, apparatus, or device.

A computer-readable signal medium can include a propagated data signal with computer-readable program code embodied therein, for example, in baseband or as part of a carrier wave. Such a propagated signal can take any of a variety of forms, including, but not limited to, electro-magnetic, optical, or any suitable combination thereof. A computer-readable signal medium can be any computer-readable medium that is not a computer-readable storage medium and that communicates, propagate, or transport a program for use by or in connection with an instruction execution system, apparatus, or device.

Program code embodied on a computer-readable medium can be transmitted using any appropriate medium, including but not limited to wireless, wireline, optical fiber cable, RF, etc., or any suitable combination of the foregoing. Computer program code for carrying out operations for embodiments of the present invention can be written in any combination of one or more programming languages, including an object oriented programming language such as Java, Smalltalk, C++ or the like, conventional procedural programming languages such as the “C” programming language, a hardware description language such as Verilog, or similar programming languages. The program code can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider).

The computer program instructions can also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Based on the foregoing a method, system and computer program product for collaboratively editing document types, and presenting the edited document types on one or more collaborative tools has been described. However, numerous modifications and substitutions can be made without deviating from the scope of the present invention. In this regard, each block in the flowcharts or block diagrams can represent a module, segment, or portion of code, which comprises one or more executable instructions for implementing the specified logical function(s). It should also be noted that, in some alternative implementations, the functions noted in the block can occur out of the order noted in the Figures. Therefore, the present invention has been disclosed by way of example and not limitation.

What is claimed is:

1. A method for presenting revision history for collaboratively edited documents within a computer system, the method comprising the steps of:
responsive to a requestor and a responder utilizing one or more collaborative tools during editing sessions of documents, tracking edits to the documents according to an ordering of the edits without changing the document;
identifying designated portions of edits of information of the documents;
extracting the designated portions of the edits of the document; and
responsive to the requestor or the responder enabling a time view on the one or more collaborative tools, presenting extracted designated portions of the edits.

2. The method according to claim 1, wherein the extracted designated portions of edits are transmitted to the one or more collaborative tools, and wherein the one or more collaborative tools are adapted to track and present the designated portions of edits in a user interface of a presentation program.

3. The method according to claim 1, wherein the time view is selected from a list consisting of entry, timestamp, collaborative session, abstracted section, user interactions, and number of revisions of the edits of the documents.

4. The method according to claim 3, further comprising:
enabling change of view of the time view of one or more collaborative tools; and
responsive to time view selections by a requestor or a responder, presenting progression of edits of the documents over a selected range of time.

5. The method according to claim 4, further comprising:
utilizing a unique identifier for each edit of information of the documents; and
identifying an unedited portion of information as a portion of the documents without the unique identifier.

6. The method according to claim 5, wherein the unique identifier is presented as mixture of colors based on the edits.

7. The method according to claim 6, further comprising:
enabling transmission of edits between one or more collaborative tools, wherein a requestor or a responder copies time view of edits between the one or more collaborative tools, and wherein the requestor or the responder selects editing indication including the mixture of colors for presenting the edits.

8. A computing system for collaboratively sharing portions of a web document, the computing system comprising:
one or more processors, one or more computer-readable memories, one or more computer-readable tangible storage devices and program instructions which are stored on at least one of the one or more storage devices for execution by at least one of the one or more processors via at least one of the one or more memories, the program instructions comprising:
program instructions to track edits to documents according to an ordering of the edits without changing the document, responsive to a requestor or a responder utilizing one or more collaborative tools during editing sessions of the documents;
program instructions to identify designated portions of edits of information of the documents;
program instructions to extract the designated portions of the edits of the document; and
program instructions to present extracted designated portions of the edits of the document, responsive to the requestor or the responder enabling a time view on the one or more collaborative tools.

9. The computing system according to claim 8, wherein the extracted designated portions of edits are transmitted to the one or more collaborative tools, and wherein the one or more collaborative tools are adapted to track and present the designated portions of edits in a user interface of a presentation program.

10. The computing system according to claim 8, wherein the time view is selected from a list consisting of entry, timestamp, collaborative session, abstracted section, user interactions, and number of revisions of the edits of the documents.

11. The computing system according to claim 10, further comprising:
program instructions to enable change of view of the time view of one or more collaborative tools; and
program instructions to present progression of edits of the documents over a selected range of time, responsive to time view selections by a requestor or a responder.

12. The computing system according to claim 11, further comprising:
program instructions to utilize a unique identifier for each edit of information of the documents; and
program instructions to identify an unedited portion of information as a portion of the documents without the unique identifier.

13. The computing system according to claim 12, wherein the unique identifier is presented as mixture of colors based on the edits.

14. The computing system of claim 13, further comprising:
program instructions to enable transmission of edits between one or more collaborative tools, wherein a requestor or a responder copies time view of edits between the one or more collaborative tools, and wherein the requestor or the responder selects editing indications including the mixture of colors for presenting the edits

15. A computer program product for collaboratively sharing portions of a web document, the computer program product comprising:
one or more computer-readable tangible storage media and program instructions stored on at least one of the one or more storage media, the program instructions comprising:
program instructions to track edits to documents according to an ordering of the edits without changing the document, responsive to a requestor or a responder utilizing one or more collaborative tools during editing sessions of the documents;
program instructions to identify designated portions of edits of information of the documents;
program instructions to extract the designated portions of edits of information of the document; and
program instructions to, present extracted designated portions of the edits of the document, responsive to the requestor or the responder enabling a time view on the one or more collaborative tools.

16. The computer program product according to claim 15, wherein the extracted designated portions of edits are transmitted to the one or more collaborative tools, and wherein the one or more collaborative tools are adapted to track and present the designated portions of edits in a user interface of a presentation program.

17. The computer program product according to claim 15, wherein the time view is selected from a list consisting of entry, timestamp, collaborative session, abstracted section, user interactions, and number of revisions of the edits of the documents.

18. The computer program product according to claim 17, further comprising:
program instructions to enable change of view of the time view of one or more collaborative tools; and
program instructions to present progression of edits of the documents over a selected range of time, responsive to time view selections by a requestor or a responder.

19. The computer program product according to claim 18, further comprising:
program instructions to utilize a unique identifier for each edit of information of the documents; and
program instructions to identify an unedited portion of information as a portion of the documents without the unique identifier.

20. The computer program product of claim 15, further comprising:
program instructions to enable transmission of edits between the one or more collaborative tools, wherein the requestor or the responder copies time view of edits between the one or more collaborative tools, and wherein the requestor or the responder selects editing indications including a mixture of colors for presenting the edits.
